(19) United States
(12) Patent Application Publication
(10) Pub. No.: US 2019/0318658 A1
(43) Pub. Date: Oct. 17, 2019

(54) BALLISTIC DEVICE AS A TEACHING TOOL

(71) Applicant: The Prophet Corporation, Owatonna, MN (US)

(72) Inventors: Jason Butler Koberstine, Apple Valley, MN (US); Todd Russell Jennings, Sunfish Lake, MN (US)

(21) Appl. No.: 16/384,366

(22) Filed: Apr. 15, 2019

Related U.S. Application Data
(60) Provisional application No. 62/658,309, filed on Apr. 16, 2018.

(51) Int. Cl. G09B 23/06; F41B 3/03

(52) U.S. Cl. CPC G09B 23/06; F41B 3/03

(57) ABSTRACT

A ballistic device is easily and safely operated and modified by students to change different variables between experiments performed by the students. For example, the ballistic device is configured to facilitate adjusting the number and/or strength of the tensioning members applying a bias to the launching member to facilitate adjusting a location of the launch pad along a length of the launching member. A trigger arrangement is configured to be actuated at a safe distance from the ballistic device.

### CROSS REFERENCE TO RELATED APPLICATION

This application claims the benefit of U.S. Provisional Application No. 62/658,309, filed Apr. 16, 2018, and titled “Ballistic Device as a Teaching Tool,” the disclosure of which is hereby incorporated herein by reference.

### BACKGROUND

Existing tools for teaching physics concepts to students tend to be sized for individual, table-top use. Certain types of teaching tools include constructions sets from which students build various machines or tools. For example, students may build a ballistic device from which the student can perform trajectory experiments. However, the ballistic devices tend to be simplified to enable quick and easy assembly by the students. Such ballistic devices tend to be limited in what type of modifications can be made during the experiments.

Improvements are required.

### SUMMARY

Aspects of the disclosure are directed to a ballistic-device-type teaching tool to aid in teaching physics concepts to students. The ballistic device includes a frame and a launcher arm. Because the ballistic device is a teaching tool, the ballistic device can be easily modified by students to change different variables between experiments performed by the students.

In certain implementations, the ballistic device includes a plurality of tensioning members. At least one of the tensioning members is configured to apply a different amount of tension than another of the tensioning members. In certain implementations, the ballistic device is configured to facilitate installation and removal of selected ones of the tensioning members. Accordingly, a user can choose the amount of force at which the ballistic device is operated by selecting which of the tensioning members to install at the ballistic device.

In certain examples, the ballistic device is configured to enable a quick connect and quick disconnect of the tensioning members. For example, the ballistic device may include hooks at which ends of the tensioning members can be slid about and retained.

In certain examples, the tensioning members are grouped in pairs with each pair being configured to apply a common amount of tension. In an example, the tensioning members include at least two different pairs. In another example, the tensioning members include at least three different pairs.

In certain examples, the tensioning members are color-coded based on the amount of tension the tensioning members are configured to apply. In certain examples, the tensioning members include resistance bands.

In certain implementations, the ballistic device includes an adjustable launch pad. The launcher arm defines a plurality of pre-set load positions at which the launch pad can be mounted. The launch pad and launcher arm are configured to facilitate installation and removal of the launch pad at any of the pre-set load positions. Accordingly, students can adjust a length of a moment arm of the ballistic device without changing a size of the launcher arm itself. In certain examples, the launch pad can be fastened to the launcher arm at any of the pre-set load positions. In an example, the launch pad is fastened using wing nuts or other easily removable fastener.

In certain examples, the launch pad includes a shallow tray. In an example, a flying disc is used as the launch pad.

In certain implementations, the ballistic device includes a trigger arrangement that facilitate actuating the launcher arm from a location remote from the ballistic device. The ballistic device is a teaching tool and, hence, is intended to be operated by students (e.g., children). Accordingly, the trigger arrangement enables a student to operate the trigger arrangement from a safe distance away from the ballistic device.

In certain examples, the trigger arrangement includes a tether that can be pulled by a student standing at the remote location. In certain examples, the trigger arrangement includes a release member coupled to the tether. The release member engages a retention member on the launcher arm and a retention member on the frame to hold the launcher arm in a cocked position relative to the frame. Actuating the trigger arrangement disconnects the release member from the retention members, which enables the launcher arm to move to a fired position. In certain examples, the retention members include eyehooks and the release member includes a pin.

In certain implementations, the ballistic device is relatively lightweight and/or easy to assemble. In certain examples, the ballistic device is formed from plastic. In certain examples, the ballistic device is formed from plastic conduits or pipes interconnected by plastic joints.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of an example teaching system including a ballistic device having a launching arm coupled to a frame, a series of tensioning members, and a series of payloads;

FIG. 2 is a perspective view of the ballistic device of FIG. 1 shown with multiple tensioning members coupled to the launching arm without be operably coupled to an installation arrangement of the ballistic device;

FIG. 3 is an enlarged view of the first set of hooks of an example installation arrangement suitable for use with the ballistic device of FIG. 2;

FIG. 4 is a top plan view of the ballistic device of FIG. 2 with multiple tensioning members operably coupled to the installation arrangement;

FIG. 5 is a perspective view of the ballistic device of FIG. 4;

FIG. 6 is an enlarged view of an example trigger arrangement suitable for use with the ballistic device of FIG. 2;

FIG. 7 is a side elevational view of the ballistic device of FIG. 4 with the launching arm shown in the cocked position;

FIG. 8 is a side elevational view of the ballistic device of FIG. 7 with the launching arm shown part way between the cocked position and the fired position;

FIG. 9 is a side elevational view of the ballistic device of FIG. 7 with the launching arm shown in the fired position;

FIG. 10 is an enlarged view of the second end of the launching arm of the ballistic device of FIG. 4 showing the launch pad exploded from the launching arm for ease in viewing the various pre-set load positions; and

FIG. 11 is an enlarged view of the launch pad mounted to the launching arm of FIG. 10 with a payload shown disposed on the launch pad.

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

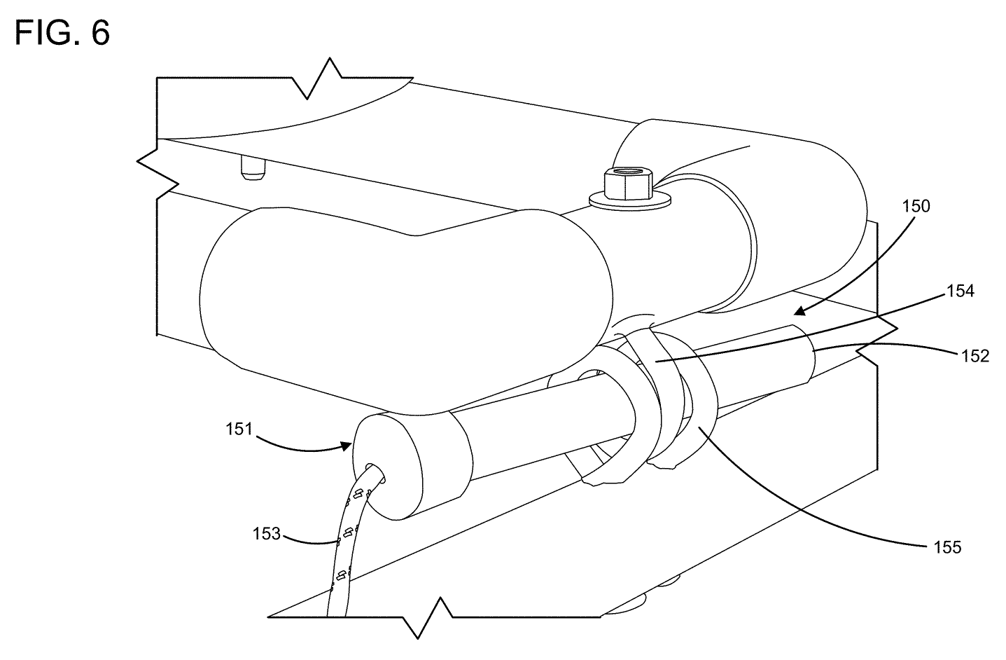

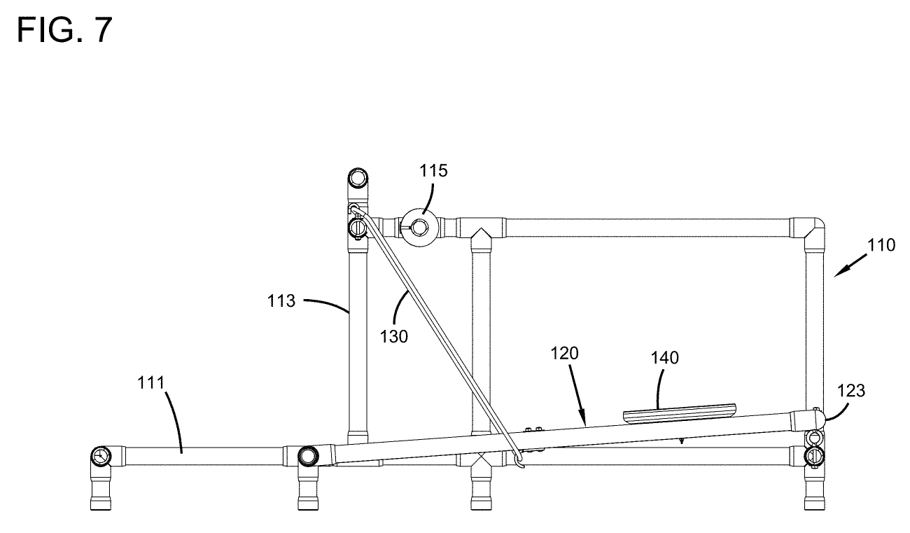

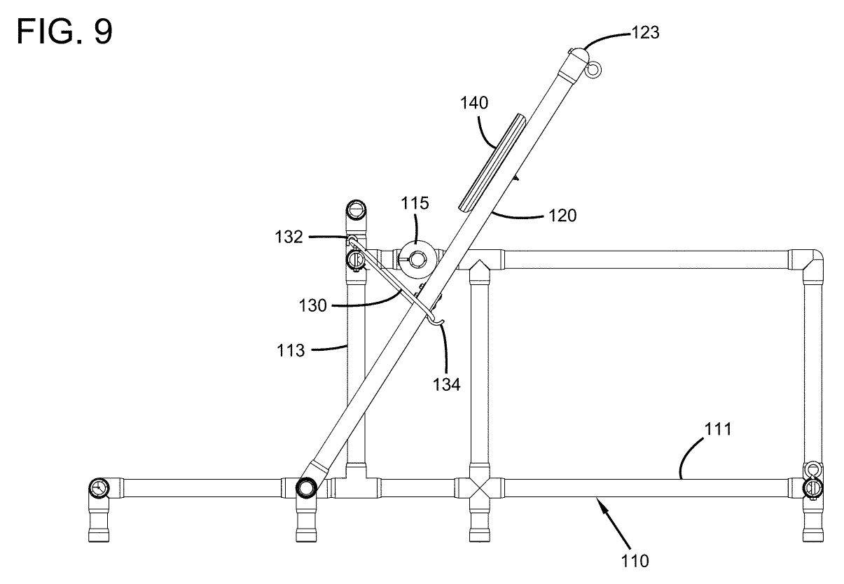

Referring to the figures in general, the present disclosure is directed to a ballistic-device-type teaching tool 100 for use in teaching physics concepts to students. The ballistic device 100 includes a frame 110 and a launching member 120 configured to pivot or rotate relative to the frame 110 between a cocked position (FIG. 7) and a fired position (FIG. 9). The launching member 120 is biased towards the fired position by one or more tensioning members 130. The launching member 120 includes a launch pad 140 on which a payload 160 may be seated while the launching member 120 is disposed in the cocked position. A trigger arrangement 150 holds the launching member 120 in the cocked position until actuated (see FIG. 6). Actuating the trigger arrangement 150 releases the launching member 120 to move towards the fired position, thereby hurling the payload from the launch pad 140. In an example, the ballistic device 100 includes a catapult.

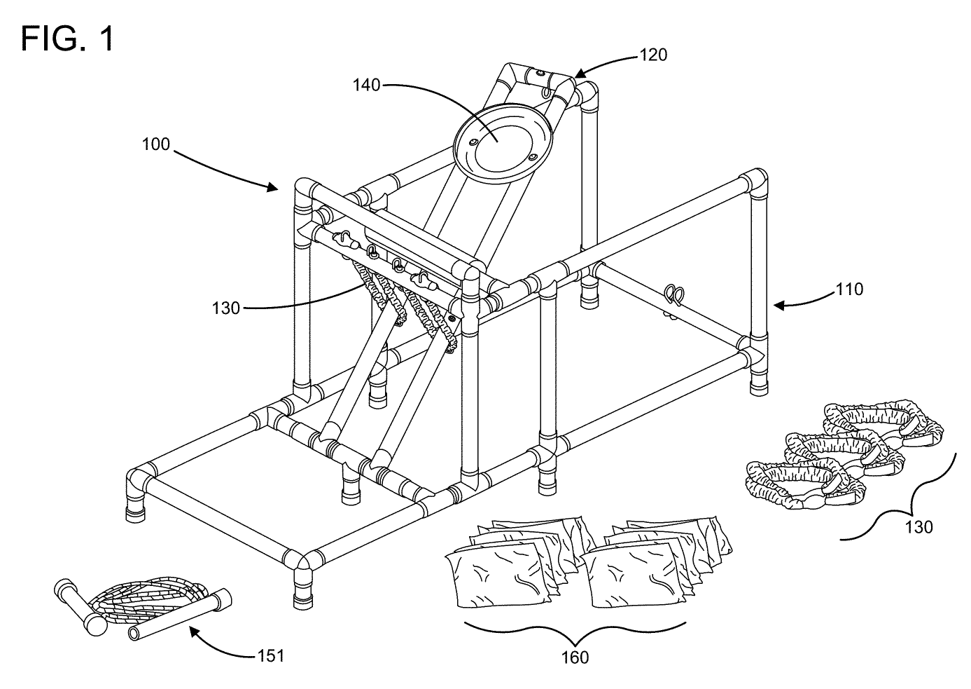

In the example shown in FIG. 1, the ballistic device 100 forms part of a teaching system that includes multiple tensioning devices 130, multiple payloads 160, and/or a remotely operable release member 151. Because the ballistic device 100 is a teaching tool, the ballistic device 100 can be easily and safely operated and modified by students to change different variables between experiments performed by the students. In certain implementations, the ballistic device 100 is configured to facilitate adjusting the number and/or strength of the tensioning members 130 applying a bias to the launching member 120 as will be described in more detail below. In certain implementations, the ballistic device 100 is configured to facilitate adjusting a location of the launch pad along a length of the launching member 120 (i.e., the moment arm of the launch pad) as will be described in more detail below. In certain implementations, the trigger arrangement 150 is configured to be actuated at a safe distance from the ballistic device as will be described in more detail below.

In general, the frame 110 includes a base 111 and a tension support member 113. The base 111 extends along a length of the frame 110 between a front 101 and a rear 102 of the ballistic device 100. The base 111 also extends along a width of the frame 110 between a first side 103 and a second side 104 of the ballistic device 100. The tension support member 113 extends upwardly from the base 111 along a height of the ballistic device 100. The height extending between a top 105 and a bottom 106 of the ballistic device 100.

The base 111 is configured to seat on a surface (e.g., a floor, the ground, etc.). In some examples, the base 111 includes one or more feet 112 configured to seat on the surface. In other examples, the base 111 defines an elongate structure that seats on the surface.

The launching member 120 is coupled to the base 111. For example, the launching member 120 includes an arm 121 extending between a first end 122 and a second end 123. The first end 122 pivotally or rotationally couples to the base 111 to enable the second end 123 of the launching member 120 to move between the cocked and fired positions. In certain examples, the launching member 120 is not easily removable from the base 111.

In certain implementations, the tension support member 113 includes a padded region 115 against which the launching member 120 impacts upon reaching the fired position. The padded region 115 protects the launching member 120 from damage that would otherwise be caused by the forceful collision of the launching member 120 and the tension support member 113. In certain examples, the padded region 115 is formed by padding mounted over a bar 114 extending along the width of the ballistic device 100.

In certain implementations, the ballistic device 100 is relatively lightweight and/or easy to assemble. In certain examples, the ballistic device 100 is formed from plastic. In certain examples, the ballistic device 100 is formed from plastic conduits or pipes interconnected by plastic joints. The conduits or pipes can be glued, fastened, friction-fit, or otherwise secured together via the joints.

In certain implementations, the ballistic device 100 is sized to be easily visible to multiple students during an experiment. For example, the ballistic device 100 may be sized to stand about waist-height for the students. In certain examples, the ballistic device 100 has a height between about 1 foot and about 4 feet. In certain examples, the ballistic device 100 has a height between about 2 feet and about 3 feet. In certain examples, the ballistic device 100 has a height of between 20 inches and thirty inches. In other examples, however, the ballistic device 100 can be any desired height. In certain examples, the ballistic device 100 has a length of between about 3 feet and about 7 feet. In certain examples, the ballistic device 100 has a length of between about 4 feet and about 6 feet. In certain examples, the ballistic device 100 has a length of between about 50 inches and about 60 inches. In other examples, however, the ballistic device 100 can be any desired length.

In certain implementations, the ballistic device 100 includes a plurality of tensioning members 130. At least one of the tensioning members 130 is configured to apply a different amount of tension than another of the tensioning members 130. In certain examples, the tensioning members 130 are grouped in pairs with each pair being configured to apply a common amount of tension. In an example, the tensioning members 130 include at least two different pairs. In another example, the tensioning members 130 include at least three different pairs. In certain examples, the tensioning members 130 are color-coded based on the amount of tension the tensioning members 130 are configured to apply.

In certain examples, the tensioning members 130 include resistance bands. For example, each tensioning member 130 may form a closed loop. In certain examples, the tensioning members 130 include an elastic loop covered in a fabric that inhibits pinching by the elastic loop and/or protects the elastic loop. In certain examples, the tensioning members 130 are generally the same size as each other.

In certain implementations, the ballistic device 100 is configured to facilitate installation and removal of selected ones of the tensioning members 130. Accordingly, a user can choose the amount of force at which the ballistic device 100 is operated by selecting which of the tensioning members 130 to install at the ballistic device 100. For example, the ballistic device 100 may include an installation arrangement 135 to enable a quick connect and quick disconnect of the tensioning members 130. For example, the installation arrangement 135 may include hooks 132, 134 about which the tensioning members 130 can be retained.

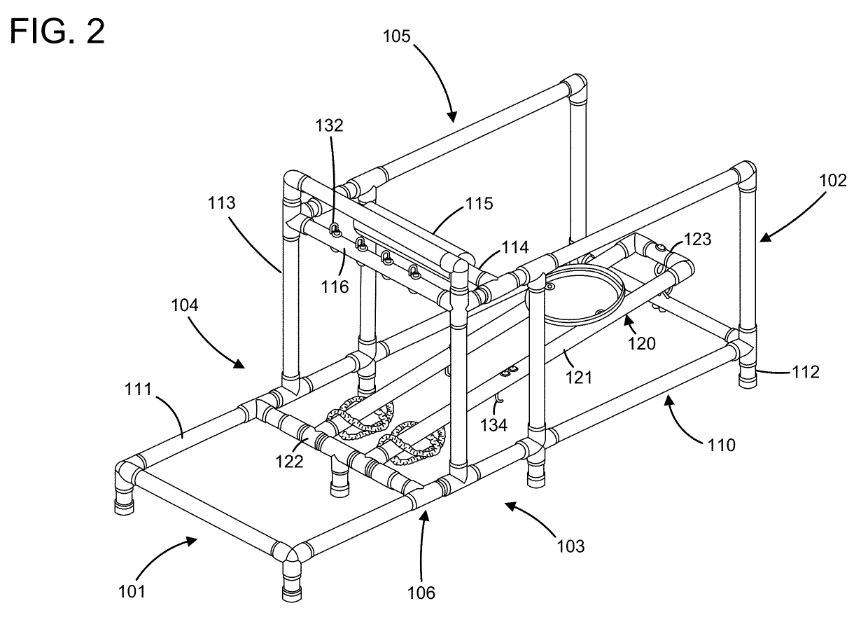

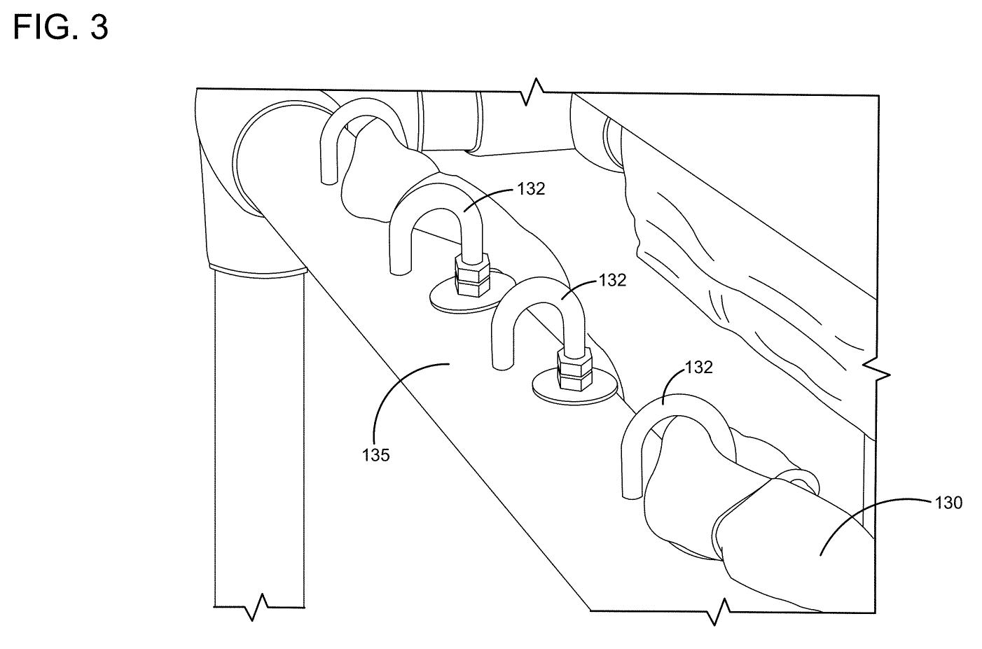

In certain implementations, the installation arrangement 135 includes a first set of one or more hooks 132 mounted to the frame 110 (FIG. 3) and a second set of one or more hooks 134 mounted to the launching member 120 (FIGS. 2 and 6). Each tensioning member 130 is mounted about one of the hooks 132 from the first set and about one of the hooks 134 from the second set (e.g., see FIG. 1). Accordingly, each tensioning member 130 applies a biasing force pulling the respective hooks 132, 134 together. The hooks 132, 134 are mounted to face away from each other to retain the tensioning member 130 at the hooks 132, 134.

In some implementations, the tensioning members 130 are separate from the ballistic device 100 until installed on the ballistic device 100. In other implementations, however, the tensioning members 130 can be pre-mounted to the ballistic device 100 without being operably connected between the launching member 120 and the frame 110. In certain examples, the tensioning members 130 can be mounted to the launching member 120 without being coupled to the frame 110 (e.g., see FIG. 2). For example, the tensioning members 130 can be looped over the launching member 120 at a separate location from the hooks 134.

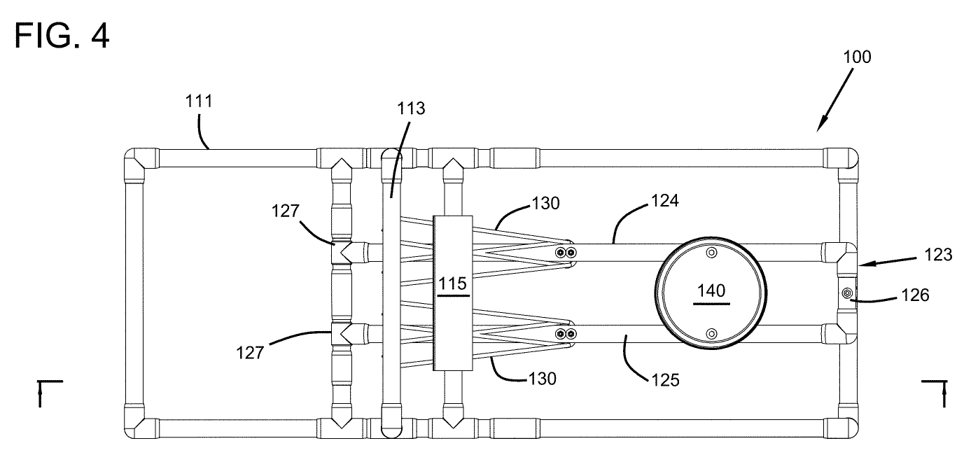

Referring to FIG. 4, in certain examples, the launching member 120 is formed from two rods 124, 125 connected at the second end 123 by a cross-member 126. As will be described herein, the launch pad 140 mounts across the two rods 124, 125. Each rod 124, 125 is separately mounted to the frame 110 at the first end 122. For example, the first end 122 of each rod 124, 125 may define a hinge joint through which a cross-member of the frame 110 extends. In such examples, each rod 124, 125 may include a separate hook 134 onto which one or more tensioning members 130 can be operably installed.

In certain examples, one or more tensioning members 130 can be mounted about each rod 124, 125 without being operably installed. For example, a tensioning member 130 is operably installed when the tensioning member 130 engages both one of the hooks 132 on the frame 110 and one of the hooks 134 on the launching member 120. The tensioning member 130 is not operably installed when the tensioning member 130 is merely looped around the rod 124, 125.

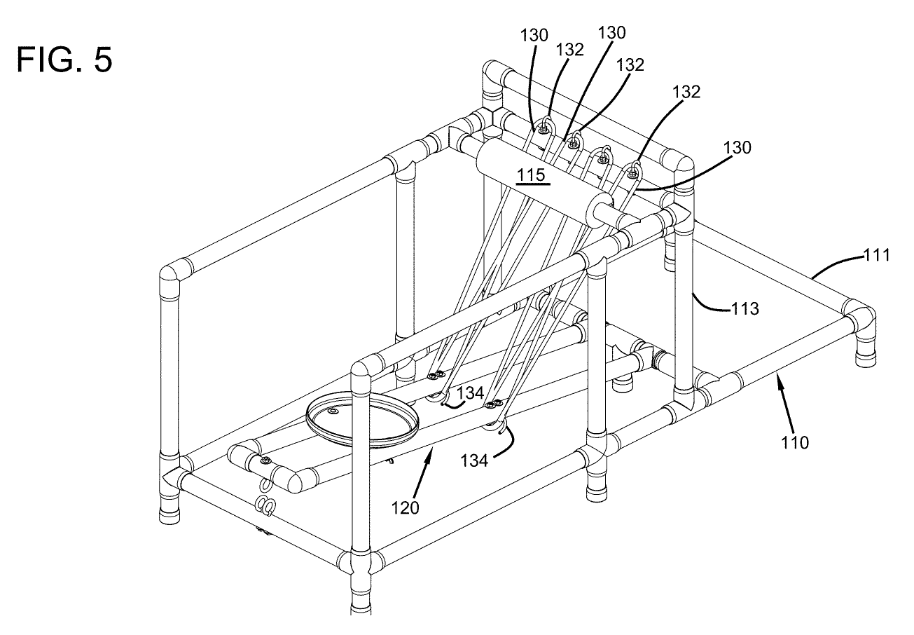

In certain implementations, multiple tensioning members 130 can be operably installed at each bar 124, 125 to create a biasing force on the launching member 120. For example, in FIG. 5, two tensioning members 130 are shown operably installed at each rod 124, 125. The tension force of both tensioning members 130 is cumulatively applied to the respective rod 124, 125. In the example shown, each tensioning member 130 is operably installed at a separate hook 132 on the tension support member 113. In other examples, however, multiple tensioning members 130 can be operably installed at the same hook 132.

In certain implementations, the ballistic device 100 includes a trigger arrangement 150 (FIG. 6) that facilitate actuating the launching member 120 at a location remote from the ballistic device 100. The ballistic device 100 is a teaching tool and, hence, is intended to be operated by students (e.g., children). Accordingly, the trigger arrangement enables a student to operate the trigger arrangement from a safe distance away from the ballistic device 100.

In certain examples, the trigger arrangement 150 includes a release member 151 that can be actuated by a student standing at the remote location. In certain examples, the release member 151 includes a pin 152 coupled to the tether 153. The release member 151 engages a retention member 154 on the launching member 120 and a retention member 155 on the frame 110 to hold the launching member 120 in a cocked position relative to the frame (see FIGS. 6 and 7).

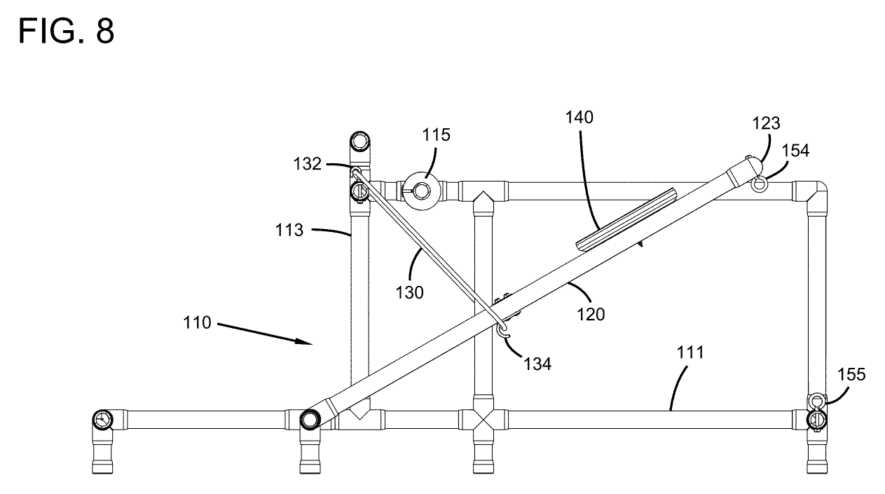

Actuating the trigger arrangement 150 disconnects the release member 151 from the retention members 154, 155, which enables the launching member 120 to move to the fired position. In certain examples, the retention members 154 155 include eyehooks. In certain examples, a student actuates the trigger by pulling on the tether 153 at a location remote from the ballistic device 100. Pulling the tether 153 pulls the pin 152 through the eyehooks 154, 155. As shown in FIGS. 7-9, the tensioning member(s) 130 pull the launching member 120 upwardly towards the tension support member 113. In an example, the tensioning member(s) 130 pull the launching member 120 against the padded region 115 of the tension support member 113.

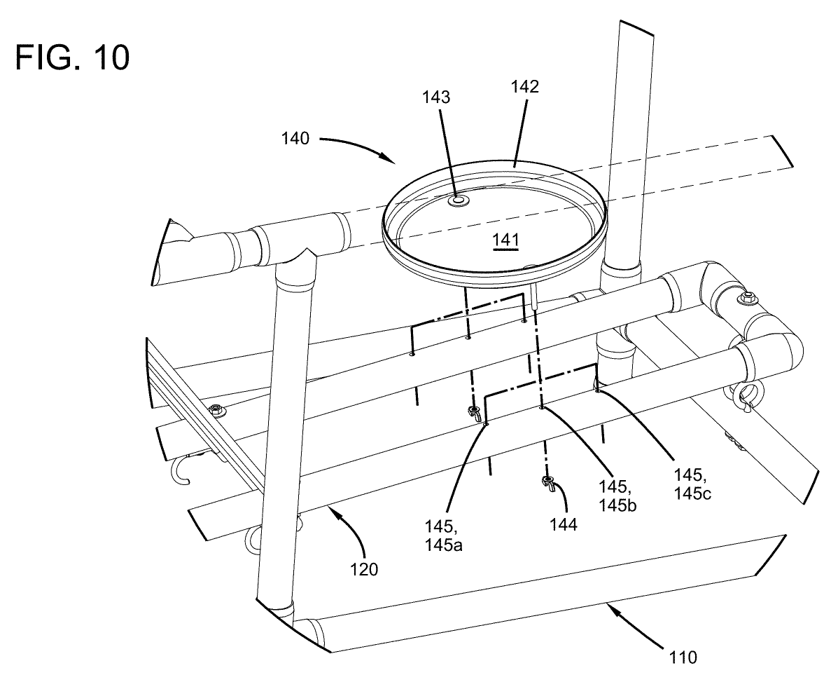

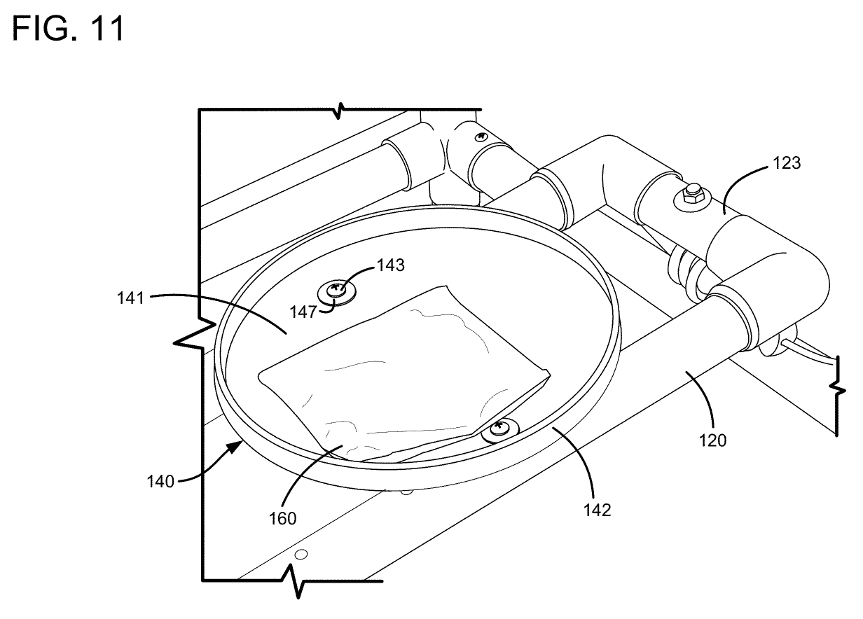

Referring to FIGS. 10 and 11, in certain implementations, the ballistic device 100 includes an adjustable launch pad 140. The launching member 120 defines a plurality of pre-set load positions 145 at which the launch pad 140 can be mounted. In certain examples, the launch pad 140 can be fastened to the launching member 120 at any of the pre-set load positions 145. Accordingly, students can adjust a length of a moment arm of the ballistic device 100 without changing a size of the launching member 120 itself.

In the example shown, the launching member 120 includes first, second, and third pre-set load positions 145a, 145b, 145c spaced along the length of the launching member 120. In other examples, however, the launching member 120 can define any desired number of pre-set load positions (e.g., two, four, five, six, etc.). In some examples, the pre-set load positions 145 are equally spaced from each other. In other examples, the pre-set load positions 145 can be unevenly spaced from each other. In certain implementations, the pre-set load positions 145 extend over a portion of the length of the launching member 120 disposed between the hooks 134 and the end 123 of the launching member 120. In certain examples, the pre-set load positions 145 are disposed over a smaller portion of the launching member 120.

In certain implementations, the launch pad 140 and launching member 120 are configured to facilitate installation and removal of the launch pad 140 at any of the pre-set load positions 145. For example, the pre-set load positions 145 may be defined by fastener apertures defined through the launching member 120. In certain examples, each pre-set load position 145 is defined by a pair of fastener apertures—one at each rod 124, 125 of the launching member 120. In certain examples, one or more fasteners 143 extend through the launch pad 140 and through the respective apertures at a selected one of the pre-set load positions 145.

In an example, wing nuts 144 or other retainers engage the fasteners 143 at an opposite side of the launching member 120 to secure the launch pad 140 to the launching member 120. The wing nuts 144 enable quick connection and quick release of the fasteners 143 and, hence, of the launch pad 140. In the example shown, a washer 147 may reinforce the head of the fastener 143 securing the launch pad 140 to the launching member 120.

In certain implementations, the launch pad 140 includes a shallow tray. For example, the launch pad 140 includes a relatively flat base 141 on which a payload 160 may be disposed. In certain examples, the launch pad 140 also includes a perimeter wall 142 extending upwardly from the base 141. The perimeter wall 142 aids in retaining the payload 160 at the launch pad 140 until actuation of the trigger arrangement 150. In certain examples, the launch pad 140 has an annular perimeter wall 142. In the example shown, an upside-down flying disc is used as the launch pad 140.

In certain implementations, the payload 160 includes beanbags. In other implementations, the payload 160 can include other objects such as balls, discs, or other projectiles.

In use, students can carry out one or more experiments with the ballistic device 100. For example, students can lay a target (e.g., a hoop) on the ground a distance away from the ballistic device 100 and then actuate the ballistic device 100 multiple times using the same payload 160 (or payloads of the same weight). The students can then analyze the accuracy and/or precision of the ballistic device 100. The accuracy of the device refers to how close the payloads 160 land to the target (e.g., aim). The precision refers to how close the payloads 160 land to each other (e.g., repeatability).

Students may adjust the moment arm of the ballistic device 100 by moving the launch pad 140 from one of the pre-set load positions 145 to another of the pre-set load positions 145. The students can then compare how changing the moment arm affects the accuracy and/or precision of the landing of the payloads 160.

Students may adjust the amount of force used to hurl the payload 160 by changing the number and/or type of tensioning member(s) 130. For example, the students may add or remove tensioning members 130 to increase or decrease the amount of force applied to the launching member 120. Alternatively, students may change which of the tensioning members 130 are operably coupled to the installation arrangement 135 (e.g., replace a light resistance band with a medium or heavy resistance band).

Finally, students can experiment with changing the weight of the payload 160 (e.g., by adding ore moving bean bags, by switching out bean bags of different weights, etc.).

Having described the preferred aspects and implementations of the present disclosure, modifications and equivalents of the disclosed concepts may readily occur to one skilled in the art. However, it is intended that such modifications and equivalents be included within the scope of the claims which are appended hereto.

What is claimed is:

1. A teaching tool comprising:
a frame including a base and a tension support section extending upwardly from the base, the tension support section including a first mounting region;
a launching member extending along a length between a first end and a second end, the first end being coupled to the base so that the launching member moves relative to the base to move the second end relative to the tension support section between a first position and a second position, the launching member defining a second mounting region, the launching member also defining a loading region including a plurality of pre-set load positions;
a launch pad coupled to the launching member, the launch pad being selectively positionable at any of the pre-set load positions within the loading region;
a tensioning member configured to couple to both the first mounting region of the tension support section and the second mounting region of the launching member to bias the launching member towards the second position; and
a trigger arrangement that releasably holds the second end of the launching member in the first position against the bias of the tensioning member.

2. The teaching tool of claim 1, wherein the tensioning member includes a resistance band.

3. The teaching tool of claim 2, wherein the resistance band is one of a plurality of resistance bands that can be selectively coupled and uncoupled from the first and second mounting regions.

4. The teaching tool of claim 1, wherein the trigger arrangement includes a first retention member coupled to the base, a second retention member coupled to the second end of the launching member, and a release member sized and shaped to releasably retain the first and second retention members together.

5. The teaching tool of claim 4, wherein the first and second retention members include eyehooks and wherein the release member includes a pin sized to fit through the eyehooks.

6. The teaching tool of claim 5, wherein a tether is coupled to the pin to enable the pin to be pulled out of the eyehooks from a location spaced from the base.

7. The teaching tool of claim 1, wherein the loading region is defined by a tray mounted to the launching member.

8. The teaching tool of claim 7, wherein the tray is formed by a flying disc.

9. The teaching tool of claim 7, wherein the launching arm defines a plurality of locations to which the tray is selectively mounted.

10. The teaching tool of claim 1, wherein the tension support section includes a padded region against which the second end of the launching member impacts when the launching arm pivots to the second position.

11. A method of teaching physics concepts to students using a ballistic device including a frame and a launcher arm that pivots relative to the frame, the method comprising:
selecting a resistance band from a plurality of resistance bands, wherein at least two of the resistance bands have different tensions;
mounting the selected resistance band to the ballistic device to bias the launcher arm relative to the frame towards a fired position;
selecting one of a plurality of preset load positions disposed along a length of the launcher arm;
mounting a launch pad on the launcher arm at the selected load position;
moving the launcher arm relative to the frame to a cocked position and releasably securing the launcher arm in the cocked position using a trigger;
loading a payload on the launcher arm at the launch pad; and
actuating the trigger from a location spaced from the ballistic device to enable the launch arm to move from the cocked position to the fired position, thereby hurling the payload away from the launch pad to a first landing position.

12. The method of claim 11, wherein mounting the selected resistance band to the ballistic device comprises:
mounting a first end of the resistance band to a first hook disposed on the frame; and
mounting a second end of the resistance band to a second hook disposed on the launcher arm.

13. The method of claim 11, wherein selecting a resistance band includes selecting multiple resistance bands from the plurality of resistance bands; and wherein mounting the selected resistance band to the ballistic device includes mounting the multiple resistance bands to the ballistic device, the multiple resistance bands providing a stacked bias to the launcher arm.

14. The method of claim 13, wherein each of the multiple resistance bands has a common tension with the others of the multiple resistance bands.

15. The method of claim 11, wherein the preset load positions are defined by fastener apertures defined through the launcher arm, and wherein mounting a launch pad on the launcher arm includes:
positioning the launch pad at the selected present load position; and
inserting at least one fastener through an aperture defined in the launch pad and through the fastener aperture corresponding to the selected preset load position.

16. The method of claim 11, further comprising:
moving the launch pad to another of the present load positions;
moving the launcher arm relative to the frame to the cocked position and releasably securing the launcher arm in the cocked position using the trigger;
loading another payload on the launch pad;
actuating the trigger to enable the launch arm to move from the cocked position to the fired position, thereby hurling the another payload away from the launch pad to a second landing position; and
comparing the first landing position to the second landing position.

17. The method of claim 11, wherein the launch pad includes a shallow tray, the shallow tray has an annular sidewall that curves upwardly from a bottom of the tray.

18. The method of claim 11, wherein releasably securing the launcher arm in the cocked position using the trigger comprises:
aligning a retention member of the launcher arm with a retention member of the frame; and
inserting a pin through the first and second retention members.

19. The method of claim 18, actuating the trigger from the location spaced from the ballistic device comprises pulling a tether coupled to the pin.

20. A teaching tool comprising:
a frame including a base and a tension support section extending upwardly from the base, the tension support section including a first mounting region;
a launching member extending along a length between a first end and a second end, the first end being coupled to the base so that the launching member moves relative to the base to move the second end relative to the tension support section between a first position and a second position, the launching member defining a second mounting region;
a launch pad coupled to the launching member;
an installation arrangement coupled to the frame and to the launching member;
a plurality of tensioning members coupled to the frame such as to inhibit removal from the frame, wherein each of the tensioning members is configured to be selectively operably coupled to the installation arrangement to bias the launching member towards the second position, wherein the tensioning members do not bias the launching member when not operably coupled to the installation arrangement even while coupled to the frame; and
a trigger arrangement that releasably holds the second end of the launching member in the first position against the bias of the tensioning member.
